(19) United States
(12) Patent Application Publication
(10) Pub. No.: US 2012/0109497 A1
(43) Pub. Date: May 3, 2012

(54) ABNORMAL INTER-CYLINDER AIR-FUEL RATIO IMBALANCE DETECTION APPARATUS FOR MULTI-CYLINDER INTERNAL COMBUSTION ENGINE

(75) Inventor: Takumi Anzawa, Okazaki-shi (JP)

(73) Assignee: TOYOTA JIDOSHA KABUSHIKI KAISHA, Toyota-shi (JP)

(21) Appl. No.: 13/283,703

(22) Filed: Oct. 28, 2011

(30) Foreign Application Priority Data
Oct. 28, 2010 (JP) 2010-242553

(51) Int. Cl. F02D 41/22

(52) U.S. Cl. 701/103

(57) ABSTRACT

The invention provides an abnormal inter-cylinder air-fuel ratio imbalance detection apparatus for a multi-cylinder internal combustion engine. The abnormal inter-cylinder air-fuel ratio imbalance detection apparatus is provided with: an air-fuel ratio sensor provided at an exhaust passage of the multi-cylinder internal combustion engine; an abnormal imbalance detection portion that detects an abnormal imbalance between air-fuel ratios corresponding to respective cylinders of the multi-cylinder internal combustion engine through a comparison between a value of a parameter correlative to a variation of an output of the air-fuel ratio sensor and a predetermined abnormality threshold; and a correction portion that corrects at least one of the value of the parameter and the abnormality threshold based on an atmospheric pressure.

### CROSS REFERENCE TO RELATED APPLICATIONS

This application claims the priority to Japanese Patent Application No. 2010-242553 filed on Oct. 28, 2010, which is incorporated herein by reference in its entirety including the specification, drawings and abstract.

### BACKGROUND OF THE INVENTION

1. Field of the Invention

The invention relates to an apparatus for detecting an abnormal imbalance between air-fuel ratios corresponding to respective cylinders of a multi-cylinder internal combustion engine, and in particular, the invention relates to such an apparatus that is adapted to detect, as an abnormal imbalance, a relatively large imbalance between air-fuel ratios corresponding to respective cylinders of a multi-cylinder internal combustion engine.

2. Description of Related Art

In general, in an internal combustion engine provided with an exhaust gas purification (control) system incorporating a catalyst(s), one essential control for enabling the catalyst(s) to remove harmful components in exhaust gas at a high efficiency is “air-fuel ratio control”, that is, control of the ratio between air and fuel that are mixed to provide an air-fuel mixture to be combusted in the internal combustion engine. For air-fuel ratio control, normally, an air-fuel ratio sensor(s) is provided at an exhaust passage of the internal combustion engine, and feedback control is executed such that the air-fuel ratio detected by the air-fuel ratio sensor equals a predetermined target air-fuel ratio.

In the meantime, in a multi-cylinder internal combustion engine, typically, air-fuel ratio control uses a common control amount (control value) for all the cylinders, and therefore there is a possibility that, even during the air-fuel ratio feedback control, an imbalance occur between the actual air-fuel ratios for the respective cylinders (note that such an imbalance will hereinafter be referred to as “inter-cylinder air-fuel ratio imbalance” where necessary). If the magnitude of an inter-cylinder air-fuel ratio imbalance is small, it can be corrected by the air-fuel ratio feedback control, and the catalyst(s) can remove extra harmful components in exhaust gas, which may be produced due to the inter-cylinder air-fuel ratio imbalance, and therefore any problem related to exhaust emissions is not likely to occur.

However, exhaust emissions increase when a large inter-cylinder air-fuel ratio imbalance occurs due to, for example, malfunction of a fuel injection system(s) for one or more of the cylinders. In view of this, preferably, an inter-cylinder air-fuel ratio imbalance that is large enough to cause an increase in exhaust emissions is detected as “abnormal imbalance”. In particular, for internal combustion engines for motor vehicles, to prevent or avoid the use of a motor vehicle that gives off such increased exhaust missions, there have been social demands for technologies for enabling an abnormal inter-cylinder air-fuel ratio imbalance to be detected in each motor vehicle (onboard).

As one of technologies for detecting an abnormal inter-cylinder air-fuel ratio imbalance, U.S. Pat. No. 7,152,594 describes an apparatus that determines whether an imbalance is occurring between the air-fuel ratios for the respective cylinders, through a comparison between the actual value of length of trace of a signal from an air-fuel ratio sensor and a reference trace length value extracted from a look-up table (calculated from an engine speed Ne and an intake amount Ga).

According to the apparatus described in U.S. Pat. No. 7,152,594, however, it is necessary to prepare the look-up table in which the engine speed Ne and the intake amount Ga are interrelated with the reference trace length value, which requires a tremendous amount of design work. Further, the present inventors have empirically discovered that the value of an air-fuel ratio imbalance detected by an air-fuel ratio sensor varies depending upon the atmospheric pressure, and that the lower the atmospheric pressure, the smaller the detected imbalance tends to be. More specifically, referring to FIG. 3, in a case where the air-fuel ratio detected by an air-fuel ratio sensor in an average altitude place changes as indicated by the curve b, the air-fuel ratio detected in a high altitude place where the atmospheric pressure is relatively low changes as indicated by the curve a, that is, the variation of the detected air-fuel ratio is small as compared to that indicated by the curve b. On the other hand, the air-fuel ratio detected in a low altitude place where the atmospheric pressure is relatively high changes as indicated by the curve c, that is, the variation of the detected air-fuel ratio is large as compared to that indicated by the curve b. As such, the atmospheric pressure affects an air-fuel ratio variation caused by an imbalance between air-fuel ratios for respective cylinders, and therefore, if detection of abnormal air-fuel ratio imbalances is based on a constant threshold (abnormality threshold), the detection accuracy may be low, causing even a possibility of false or erroneous detections.

### SUMMARY OF THE INVENTION

The invention provides an abnormal inter-cylinder air-fuel ratio imbalance detection apparatus for a multi-cylinder internal combustion engine, which achieves an improved detection accuracy and prevents false and/or erroneous detections.

The first aspect of the invention relates to an abnormal inter-cylinder air-fuel ratio imbalance detection apparatus for a multi-cylinder internal combustion engine. The abnormal inter-cylinder air-fuel ratio imbalance detection apparatus is provided with: an air-fuel ratio sensor provided at an exhaust passage of the multi-cylinder internal combustion engine; an abnormal imbalance detection portion that detects an abnormal imbalance between air-fuel ratios corresponding to respective cylinders of the multi-cylinder internal combustion engine through a comparison between a value of a parameter correlative to a variation of an output of the air-fuel ratio sensor and a predetermined abnormality threshold; and a correction portion that corrects at least one of the value of the parameter and the abnormality threshold based on an atmospheric pressure.

The second aspect of the invention relates to an abnormal inter-cylinder air-fuel ratio imbalance detection method for a multi-cylinder internal combustion engine. The abnormal inter-cylinder air-fuel ratio imbalance detection method includes: detecting an air-fuel ratio in an exhaust passage of the multi-cylinder internal combustion engine; detecting an abnormal imbalance between air-fuel ratios corresponding to respective cylinders of the multi-cylinder internal combustion engine through a comparison between a value of a parameter correlative to a variation of the detected air-fuel ratio and a predetermined abnormality threshold; and correcting at least one of the value of the parameter and the abnormality threshold based on an atmospheric pressure.

Factoring the influence of the atmospheric pressure into the detection of abnormal inter-cylinder fuel-ratio imbalances, the abnormal inter-cylinder air-fuel ratio imbalance detection apparatus and method of the invention provide a significant advantage that the detection accuracy improves, preventing false and/or erroneous detections.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of the configuration of an internal combustion engine in an example embodiment of the invention;

FIG. 2 is a chart illustrating output characteristics of a catalyst upstream-side sensor and a catalyst downstream-side sensor;

FIG. 3 is a chart illustrating how the output of an air-fuel ratio sensor varies depending upon the atmospheric pressure;

FIG. 4 is an enlarged view of the portion highlighted by the square IV in FIG. 3;

FIG. 5 is an example of an atmospheric pressure/correction coefficient map;

FIG. 6 is a flowchart illustrating a routine for detecting an abnormal inter-cylinder air-fuel ratio imbalance; and

FIG. 7 is a graph illustrating, using values actually detected at different atmospheric pressures, how a relation between an air-fuel ratio and an air-fuel ratio variation varies depending upon the atmospheric pressure.

### DETAILED DESCRIPTION OF EMBODIMENTS

Hereinafter, an example embodiment of the invention will be described with reference to the accompanying drawings.

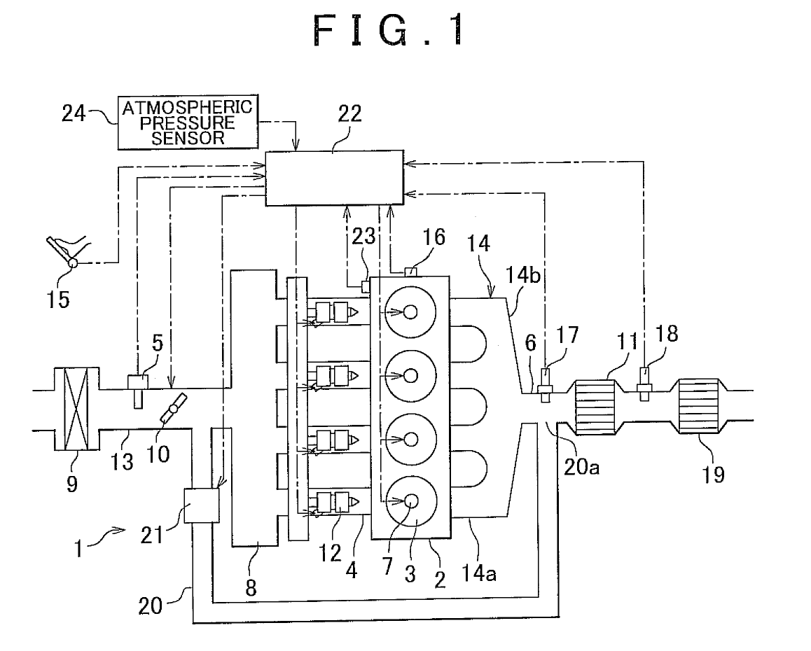

FIG. 1 is a schematic view of the configuration of an internal combustion engine to which the example embodiment of the invention is applied. Referring to FIG. 1, an internal combustion engine (engine) 1 produces drive force by reciprocating pistons in respective cylinders formed in a cylinder block 2 through combustion of air-fuel mixtures in combustion chambers 3 in the respective cylinders. The internal combustion engine 1 in the example embodiment is a multi-cylinder internal combustion engine mounted in a motor vehicle. More specifically, the internal combustion engine 1 is an inline 4-cylinder spark ignition gasoline engine. It is to be understood that internal combustion engines applicable to the invention are not limited to such internal combustion engines, but include various other multi-cylinder internal combustion engines having a different number of cylinders, a different cylinder layout, and so on.

Although not shown in the drawings, intake valves that open and close intake ports at the respective cylinders and exhaust valves that open and close exhaust ports at the respective cylinders are provided in the cylinder head of the internal combustion engine 1, and a camshaft(s) drives the intake and exhaust valves to open and close. Ignition plugs 7 for the respective cylinders are installed at the top of the cylinder head, and they are used to ignite air-fuel mixtures in the respective combustion chambers 3.

The intake ports at the respective cylinders are connected to a surge tank 8, serving as an intake air convergence chamber, via branch pipes 4 for the respective cylinders. An intake pipe 13 is connected to the upstream side of the surge tank 8, and an air cleaner 9 is provided at the upstream end of the intake pipe 13. An airflow meter 5 for detecting the intake amount (i.e., the amount of air taken in per unit time, that is, an intake flowrate) and an electronically controlled throttle valve 10 are provided at the intake pipe 13 in this order from the upstream side. The intake ports, the branch pipes 4, the surge tank 8, and the intake pipe 13 constitute an intake passage(s).

Injectors (fuel injection valves) 12 for injecting fuel into the intake passage, more specifically, into the respective intake ports, are provided at the respective cylinders. The fuel injected from each injector 12 is mixed with intake air, producing an air-fuel mixture. The air-fuel mixture is then drawn into the combustion chamber 3 as the intake valve opens, then is compressed by the piston, and is finally ignited by the ignition plug 7 for combustion.

Meanwhile, the exhaust ports at the respective cylinders are connected to an exhaust manifold 14. The exhaust manifold 14 is constituted of branch pipes 14a, which are the upstream portion of the exhaust manifold 14, and an exhaust gas convergence portion 14b, which is the downstream portion of the exhaust manifold 14. An exhaust pipe 6 is connected to the downstream side of the exhaust gas convergence portion 14b. The exhaust ports, the exhaust manifold 14, and the exhaust pipe 6 constitute an exhaust passage(s). The portion, located downstream of the exhaust gas convergence portion 14b of the exhaust manifold 14, of the exhaust passage serves as a convergence portion at which the exhaust gases discharged from the respective cylinders converge.

An upstream catalyst 11 and a downstream catalyst 19, which are both a three-way catalyst, are arranged in series at the upstream and downstream sides of the exhaust pipe 6, respectively. A catalyst upstream-side sensor 17, which is an air-fuel ratio sensor, is provided on the upstream side of the upstream catalyst 11 to detect an air-fuel ratio of exhaust gas. Further, a catalyst downstream-side sensor 18, which is also an air-fuel ratio sensor, is provided on the downstream side of the upstream catalyst 11 to detect an air-fuel ratio of exhaust gas. The catalyst upstream-side sensor 17 is arranged immediately before the upstream catalyst 11, while the catalyst downstream-side sensor 18 is arranged immediately after the upstream catalyst 11. The catalyst upstream-side sensor 17 and the catalyst downstream-side sensor 18 each detect an air-fuel ratio based on the concentration of oxygen in exhaust gas. As such, a single catalyst sensor, that is, only the catalyst upstream-side sensor 17 is provided at the exhaust gas convergence portion 14b in the exhaust passage. The catalyst upstream-side sensor 17 may be regarded as an example of “air-fuel ratio sensor” in the invention.

The internal combustion engine 1 has an exhaust gas recirculation (EGR) passage 20. The EGR passage 20 connects the exhaust pipe 6 at the downstream side of the exhaust gas convergence portion 14b to the intake pipe 13. An EGR control valve 21 is provided at the EGR passage 20 to open and close the EGR passage 20 as required. A branch portion 20a serving as an inlet of the EGR passage 20 is arranged to be opposed to the catalyst upstream-side sensor 17 in the exhaust pipe 6.

The ignition plugs 7, the throttle valve 10, the injectors 12, etc. are electrically connected to an electronic control unit (ECU) 22 serving as a controller. The ECU 22 incorporates a CPU (Central Processing Unit), a ROM (Read Only Memory), a RAM (Random Access Memory), input/output ports, a data storage(s), and so on, although not shown in the drawings. Referring to FIG. 1, the ECU 22 is electrically connected to the airflow meter 5, the catalyst upstream-side sensor 17, the catalyst downstream-side sensor 18, a crank angle sensor 16 for detecting the crank angle of the internal combustion engine 1, an accelerator operation amount sensor 15 for detecting the accelerator operation amount (e.g., the travel of the accelerator pedal), a coolant temperature sensor 23 for detecting the temperature of the coolant for the internal combustion engine 1, an atmospheric pressure sensor 24 disposed in the housing of the ECU 22 and detecting the atmospheric pressure, and various other sensors via A/D converters, or the like (not shown in the drawings). The ECU 22 controls, based on the values detected by the respective sensors, and the like, the ignition plugs 7, the throttle valve 10, the injectors 12, the EGR control valve 21, etc. so as to control the ignition timing, fuel injection amount, fuel injection timing, throttle opening degree, EGR amount, etc., as required. It is to be noted that the throttle opening degree is normally controlled to a value corresponding to the accelerator operation amount.

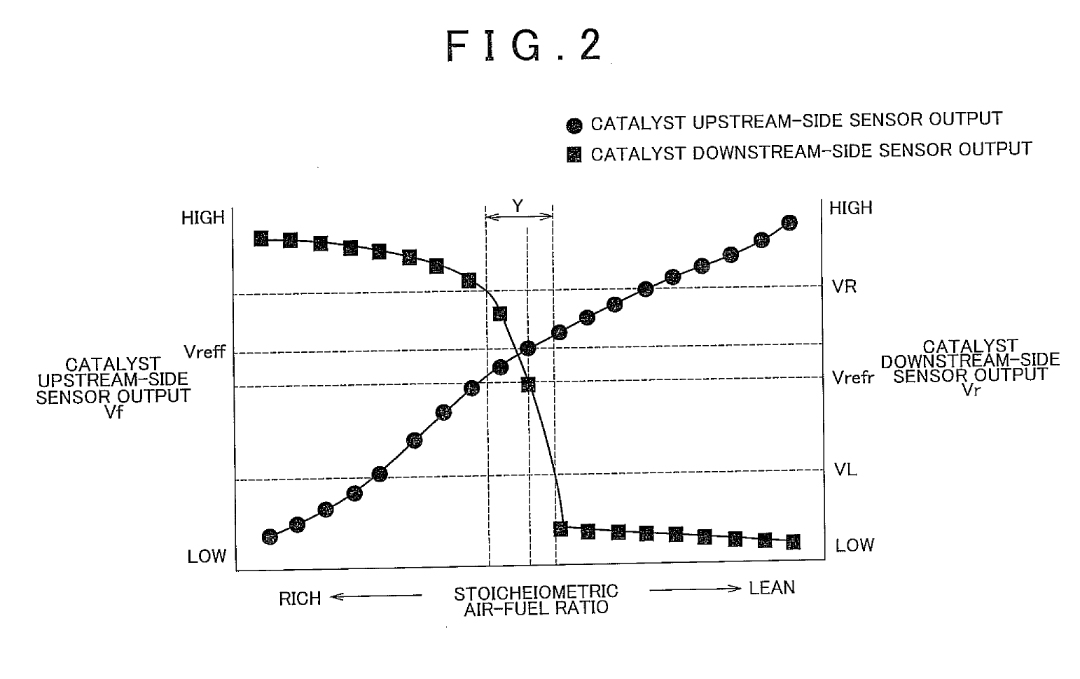

The catalyst upstream-side sensor 17 is a so-called wide-range air-fuel ratio sensor that is capable of continuously detecting air-fuel ratios in a relatively wide range. Illustrated in the chart in FIG. 2 is the output characteristic of the catalyst upstream-side sensor 17. Referring to FIG. 2, the catalyst upstream-side sensor 17 outputs a voltage signal Vf of a level proportional to the detected air-fuel ratio (“catalyst upstream-side air-fuel ratio A/Ff”). When the air-fuel ratio of exhaust gas is equal to the stoicheiometric air-fuel ratio (e.g., A/F=14.6), the output voltage is Vreff (e.g., approx. 3.3 V).

On the other hand, the catalyst downstream-side sensor 18 is a so-called oxygen sensor, having a characteristic that its output value shapely changes when changing across the level corresponding to the stoicheiometric air-fuel ratio. The chart in FIG. 2 illustrates the output characteristic of the catalyst downstream-side sensor 18. Referring to FIG. 2, the voltage output when the exhaust air-fuel ratio (catalyst downstream-side air-fuel ratio A/Fr) is equal to the stoicheiometric air-fuel ratio is equal to a stoicheiometric air-fuel ratio value Vrefr (e.g., approx. 0.45V). The output voltage of the catalyst downstream-side sensor 18 varies in a predetermined range (e.g., 0 to 1 V). When the exhaust air-fuel ratio is higher (leaner) than the stoicheiometric air-fuel ratio, the output voltage of the catalyst downstream-side sensor 18 is lower than the stoicheiometric air-fuel ratio value Vrefr. On the other hand, when the exhaust air-fuel ratio is lower (richer) than the stoicheiometric air-fuel ratio, the output voltage of the catalyst downstream-side sensor 18 is higher than the stoicheiometric air-fuel ratio value Vrefr.

The upstream catalyst 11 and the downstream catalyst 19 each remove harmful components, i.e., NOx, HC, and CO, from exhaust gas when the air-fuel ratio A/F of the exhaust gas entering the catalyst is close to the stoicheiometric air-fuel ratio. The air-fuel ratio range (window) in which these three components can be removed efficiently at the same time is relatively narrow.

The ECU 22 executes air-fuel ratio control (stoicheiometric air-fuel ratio control) to control the air-fuel ratio of the exhaust gas entering the upstream catalyst 11 to be closer to the stoicheiometric air-fuel ratio. The air-fuel ratio control includes primary air-fuel ratio control (primary air-fuel ratio feedback control) that controls the exhaust air-fuel ratio detected by the catalyst upstream-side sensor 17 to equal the stoicheiometric air-fuel ratio as a predetermined target air-fuel ratio and secondary air-fuel ratio control (secondary air-fuel ratio feedback control) that controls the exhaust air-fuel ratio detected by the catalyst downstream-side sensor 18 to equal the stoicheiometric air-fuel ratio.

An example case where an air-fuel ratio imbalance occurs between the cylinders due to malfunction of at least one of the injectors 12 at the respective cylinder is as follows. The fuel injection amount for the first cylinder #1 becomes larger than those for other cylinders #2, #3, and #4, and thus the air-fuel ratio for the first cylinder #1 deviates largely to “rich side” (i.e., becomes far richer than normal). Even in such a case, the air-fuel ratio of the total gas flowing to the catalyst upstream-side sensor 17 may be controlled to the stoicheiometric air-fuel ratio using a relatively large correction value in the primary air-fuel ratio feedback control described above. However, in reality, the air-fuel ratios in the respective cylinders are not uniform. More specifically, the air-fuel ratio in the first cylinder #1 is much lower (richer) than the stoicheiometric air-fuel ratio, while those in the second to fourth cylinders #2 to #4 are higher (leaner) than the stoicheiometric air-fuel ratio. That is, in the case described above, the stoicheiometric air-fuel ratio is only achieved in view of the total balance, and it is clearly undesirable in terms of exhaust emissions. To counter this, the example embodiment provides an apparatus for detecting an abnormal inter-cylinder air-fuel ratio imbalance, as described in detail below.

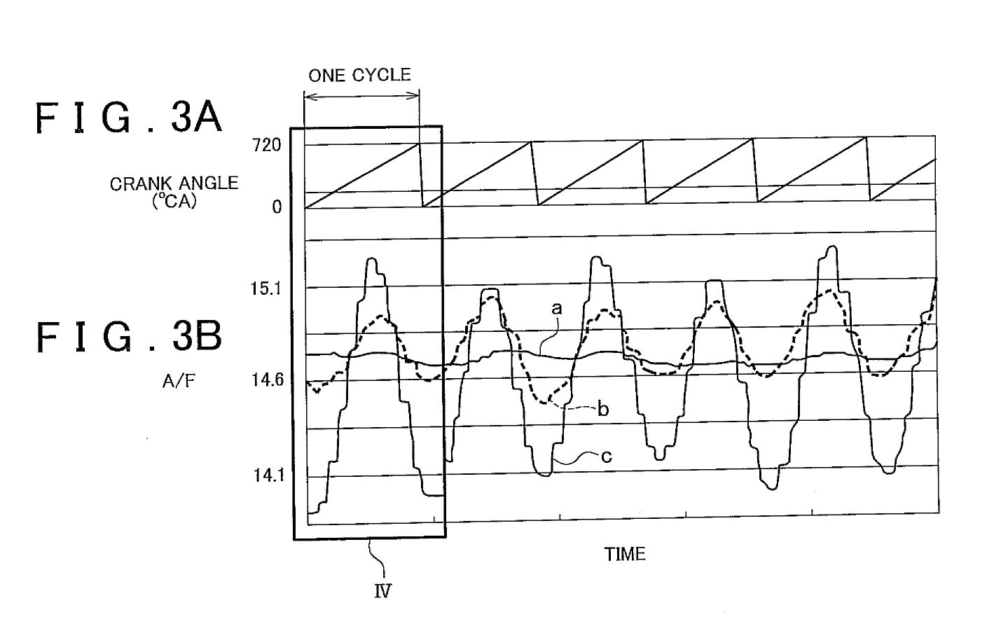

Referring to FIG. 3, the exhaust air-fuel ratio A/F detected by the catalyst upstream-side sensor 17 tends to cyclically fluctuate, where each cycle corresponds to one engine operation cycle (=720° CA). When an inter-cylinder air-fuel ratio imbalance occurs, the variation of exhaust air-fuel ratio in one engine operation cycle becomes larger. The curves a, b, and c in the section (B) of the air-fuel ratio chart in FIG. 3 represent, respectively, the value of the exhaust air-fuel ratio A/F obtained in a high altitude place (i.e., at a low atmospheric pressure), that obtained at a normal atmospheric pressure, and that obtained in a low altitude place (i.e., at a high atmospheric pressure). As is understood from FIG. 3, the lower the atmospheric pressure, the smaller the air-fuel ratio variation amplitude. It is to be noted that the illustration in FIG. 3 is a schematic illustration for facilitating understanding.

Meanwhile, “imbalance rate (%)” is a parameter indicative of the degree of an inter-cylinder air-fuel ratio imbalance. For example, the imbalance rate represents, in a case where the fuel injection amount for only one of the cylinders deviates from normal, the rate at which the fuel injection amount for the same cylinder (will hereinafter be referred to as “imbalance cylinder” where necessary) is deviating from the fuel injection amount for other cylinders free of fuel injection amount deviations (will hereinafter be referred to as “balance cylinders” where necessary), that is, from a reference fuel injection amount. When the imbalance rate is IB, the fuel injection amount for the imbalance cylinder is Qib, the fuel injection amount for the balance cylinders (i.e., the reference fuel injection amount) is Qs, the imbalance rate IB is expressed as IB=(Qib−Qs)/Qs. Thus, an increase in the imbalance rate IB indicates an increase in the deviation of fuel injection amount for the imbalance cylinder from the fuel injection amount for the balance cylinders, that is, an increase in the degree of air-fuel ratio imbalance.

(Abnormal Inter-Cylinder Air-Fuel Ratio Imbalance Detection)

As is understood from the above descriptions, when an abnormal air-fuel ratio imbalance occurs, the variation of the output of the catalyst upstream-side sensor 17 becomes larger. Thus, an abnormal air-fuel ratio imbalance can be detected by monitoring the variation of the output of the catalyst upstream-side sensor 17. In this example embodiment, therefore, the value of “variation parameter” correlative to the variation of the output of the catalyst upstream-side sensor 17 is calculated, and the calculated value of the variation parameter is compared with a predetermined abnormality determination value to detect an abnormal imbalance.

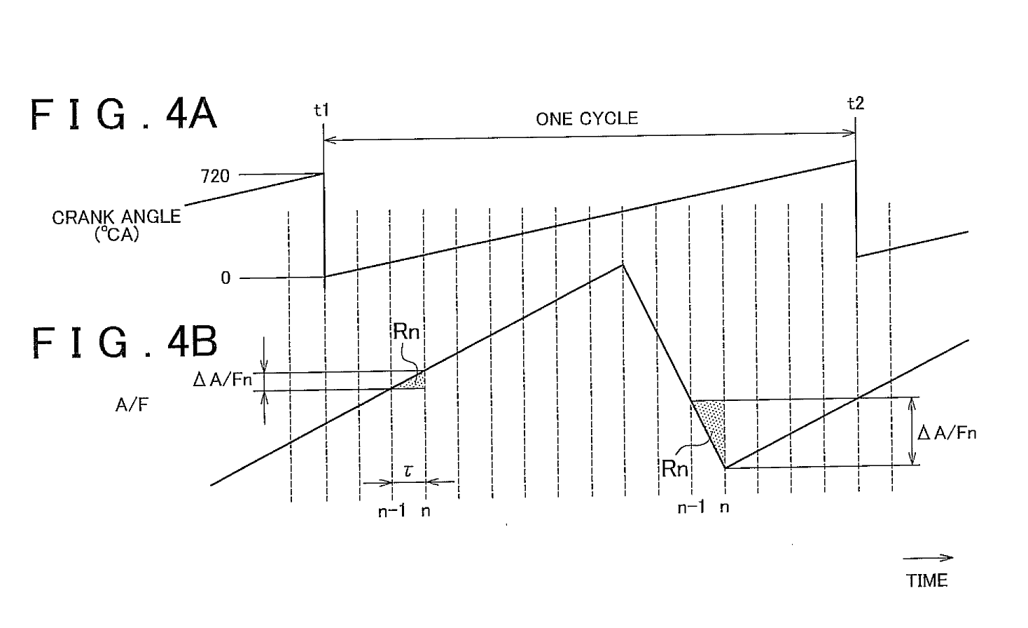

In the following, a method for calculating the value of the variation parameter will be described. FIG. 4 is an enlarged view of the portion highlighted by the square IV in FIG. 3, and in particular, it illustrates how the output of the catalyst upstream-side sensor 17 changes during an engine operation cycle. A value obtained by converting the output voltage Vf of the catalyst upstream-side sensor 17 into the air-fuel ratio A/F is used as the output of the catalyst upstream-side sensor 17. It is to be noted that the output voltage Vf of the catalyst upstream-side sensor 17 may be directly used.

Referring to the section (B) in the chart in FIG. 4, the ECU 22 obtains the value of the output A/F of the catalyst upstream-side sensor 17 at predetermined sampling cycles τ (per unit time, e.g., 4 ms) during each engine operation cycle. Further, the ECU 22 determines a difference ΔA/Fₙ between the value A/Fₙ obtained in the present cycle (second timing) and the value A/Fₙ₋₁ obtained in the last cycle (first timing), using the equation (1) indicated below. In other words, the difference ΔA/Fₙ is “differential value” or “gradient” that is newly obtained in the present cycle.

ΔA/Fₙ=A/Fₙ−A/Fₙ₋₁ (Equation 1)

To put it most simply, the difference ΔA/Fₙ represents the variation of the output of the catalyst upstream-side sensor 17. That is, the larger the variation of the output of the catalyst upstream-side sensor 17, the larger the absolute value of the gradient in the air-fuel ratio chart, i.e., the larger the absolute value of the difference ΔA/Fₙ. For this reason, the value of the difference ΔA/Fₙ in a predetermined one cycle may be used as the variation parameter.

However, in this example embodiment, for a higher accuracy, the average of multiple values of the difference ΔA/Fₙ is used as the variation parameter. In the example embodiment, the differences ΔA/Fₙ obtained in the respective sampling cycles in each engine operation cycle are integrated, and the final integral value is divided by a sample number N to obtain the average of the differences ΔA/Fₙ in the engine operation cycle. The average of the differences ΔA/Fₙ is integrated over M engine operation cycles (e.g., M=100), and the final integral value is divided by M, i.e., the number of engine operation cycles, to obtain the average of the differences ΔA/Fₙ over M engine operation cycles.

The larger the variation of the output of the catalyst upstream-side sensor 17, the larger the absolute value of the average of the differences ΔA/Fₙ over M engine operation cycles. Thus, if the absolute value of the average over M engine operation cycles is equal to or larger than a predetermined abnormality determination value, it is determined that an abnormal imbalance is occurring. On the other hand, if the absolute value of the average over M engine operation cycles is smaller than the abnormality determination value, it is determined that any abnormal imbalance is not occurring, that is, it is determined that the air-fuel ratios corresponding to the respective cylinders are all normal.

Meanwhile, the output A/F of the catalyst upstream-side sensor 17 increases and decreases depending upon various conditions. Therefore, only the difference ΔA/Fₙ or its average obtained when the output A/F of the catalyst upstream-side sensor 17 is increasing, or only that obtained when the output A/F of the catalyst upstream-side sensor 17 is decreasing may be used as the variation parameter. In particular, in a situation where the air-fuel ratio in only one of the cylinders is deviating to the rich side, the output of the catalyst upstream-side sensor 17 shapely changes to the rich side (i.e., shapely decreases) when it contacts the exhaust gas discharged from the same cylinder. Thus, only the difference ΔA/Fₙ or its average obtained when the output of the catalyst upstream-side sensor 17 decreases may be used for detecting a deviation to the rich side (rich imbalance determination). In such a case, the output indicated by the downward-sloping portion of the curve in the section (B) of the chart in FIG. 4 is used for detecting a deviation to the rich side. Basically, an air-fuel ratio tends to change at a higher rate when it decreases (i.e., changes from “lean” to “rich”) than when it increases (i.e., changes from “rich” to “lean”). Therefore, the method described above is expected to allow highly accurate detection of deviations to the rich side. However, it is to be noted that this method is merely exemplary. That is, for example, the difference ΔA/Fₙ or its average may be obtained and used only when the output of the catalyst upstream-side sensor 17 is increasing. Further, the difference ΔA/Fₙ or its average obtained when the output of the catalyst upstream-side sensor 17 and that obtained when the output of the catalyst upstream-side sensor 17 is decreasing may both be used. In this case, for example, the absolute values of the respective differences ΔA/Fₙ are integrated, and the obtained integral value is compared with a threshold.

Further, any other parameter correlative to the variation of the output of the catalyst upstream-side sensor 17 may used be as the variation parameter. For example, the difference between the maximum and minimum values of the outputs of the catalyst upstream-side sensor 17 obtained in each engine operation cycle (so-called “peak-to-peak”) may be used as the variation parameter. This is because the same difference is larger the larger the variation of the output of the catalyst upstream-side sensor 17.

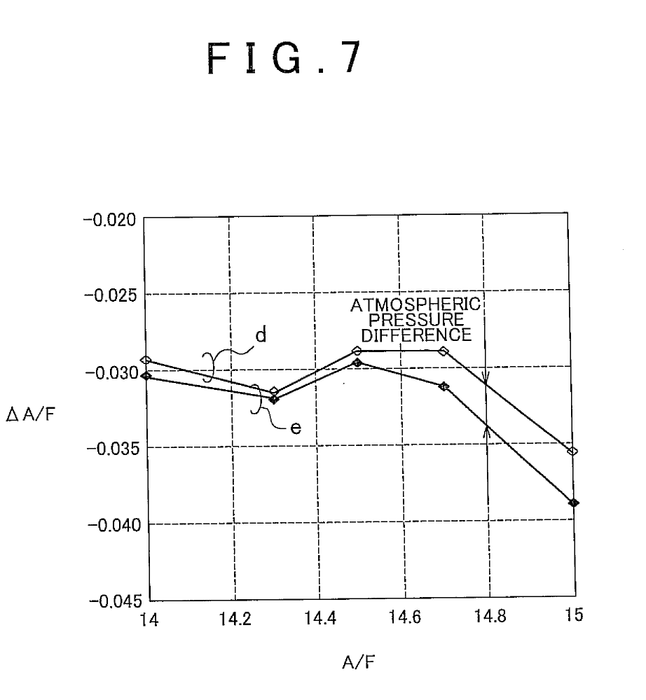

In the meantime, as mentioned earlier, the amplitude of the detected air-fuel ratio tends to decrease as the atmospheric pressure decreases. The chart in FIG. 7 illustrates, by way of example, how the difference ΔA/F obtained in a specific engine changes. Referring to FIG. 7, in the stoicheiometric air-fuel ratio region where the air-fuel ratio is approx. 14.3 to 14.7, that is, substantially equal to the stoicheiometric air-fuel ratio, the difference ΔA/F does not change largely in response to a change in the atmospheric pressure. In contrast, with regard to the regions other than the stoicheiometric air-fuel ratio region (i.e., rich and lean air-fuel ratio regions), the absolute value of the difference ΔA/F is smaller when the atmospheric pressure is relatively low (refer to the curve d in FIG. 7) than when it is relatively high (refer to the curve e in FIG. 7) (note that the chart in FIG. 7 illustrates an example situation where the air-fuel ratio is decreasing and thus the value of the difference ΔA/F is negative, and therefore the curve d is located above the curve e). Thus, if the abnormal air-fuel ratio imbalance detection is performed without correcting, according to the atmospheric pressure, the value of the variation parameter and/or “abnormality threshold” to be compared with the same value, the detection accuracy may not be sufficiently high, causing even a possibility of false or erroneous detections. In view of such a possibility, in the example embodiment, the following abnormity detection routine is executed to ensure a high detection accuracy. Meanwhile, although it is not sufficiently clear why the amplitude of detected air-fuel ratios becomes smaller the lower the atmospheric pressure, for example, a conceivable reason is that when the atmospheric pressure is low, the EGR amount (i.e., the amount of exhaust gas recirculated via the EGR passage) is small and therefore the ratio of fresh air drawn into each combustion chamber is high, thus reducing the possibility of misfires.

(Abnormal Inter-Cylinder Air-Fuel Ratio Imbalance Detection Routine)

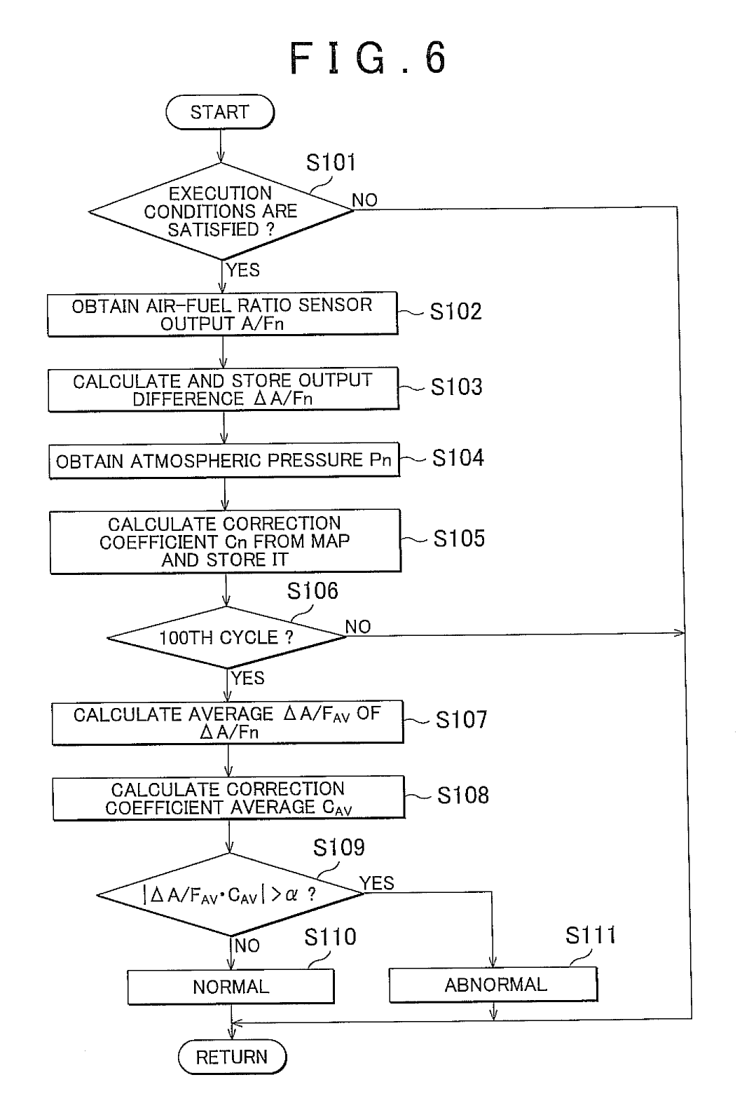

Next, an abnormal inter-cylinder air-fuel ratio imbalance detection routine will be described with reference to FIG. 6. This routine is, for example, repeatedly executed by the ECU 22 at the sampling cycles τ described above.

Referring to FIG. 6, first, it is determined in step S101 whether predetermined execution conditions for executing the abnormal imbalance detection are presently satisfied. These conditions include: (1) the engine having been warmed up (e.g., the coolant temperature detected by the coolant temperature sensor 23 being equal to or higher than a predetermined value); (2) at least the catalyst upstream-side sensor 17 being in an activated state; (3) the engine being in steady operation; (4) the engine running under the stoicheiometric air-fuel ratio control; (5) the engine running in an operation region for the abnormal imbalance detection; and (6) the output A/F of the catalyst upstream-side sensor 17 being on the decrease.

Among these, the condition (6) is set to ensure that the routine is executed only for the rich imbalance determination described above (i.e., the method for detecting an air-fuel ratio deviation to the rich side using only the values obtained when the output A/F of the catalyst upstream-side sensor 17 is decreasing). If any of the execution conditions is not satisfied, the present cycle of the routine is finished. On the other hand, if all the execution conditions are satisfied, the output A/Fₙ of the catalyst upstream-side sensor 17 (air-fuel ratio sensor) in the present cycle is obtained in step S102. Next, in step S103, the output difference ΔA/Fₙ in the present cycle is calculated using the equation (1) indicated above, and then the calculated output difference ΔA/Fₙ is stored.

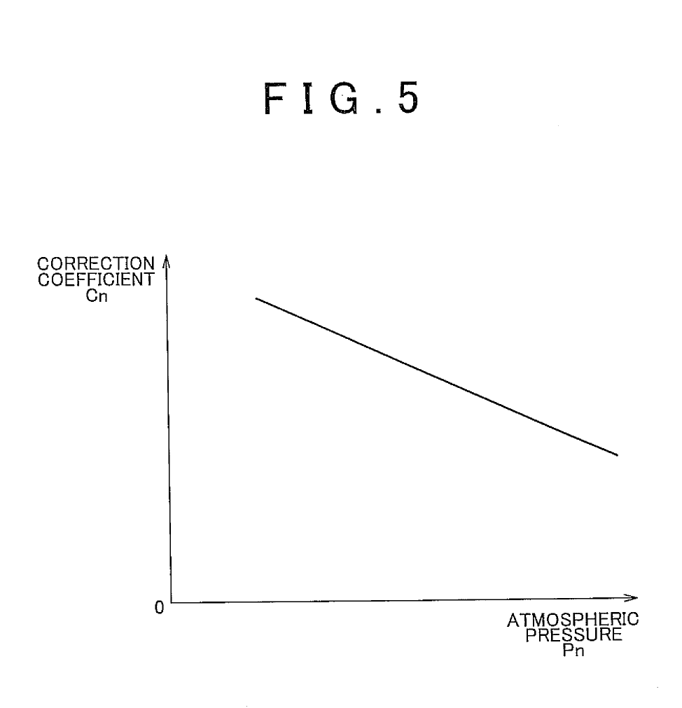

Subsequently, the value of an atmospheric pressure Pn in the present cycle is obtained in step S 104. Next, in step S 105, the value of a correction coefficient Cn corresponding to the obtained value of the atmospheric pressure Pn is calculated using a correction coefficient map (refer to FIG. 5), which is prepared in advance, and then the calculated value is stored. The correction coefficient Cn, as shown in FIG. 5, is set to be smaller the higher the atmospheric pressure Pn. In other words, the correction coefficient Cn is set to be larger the lower the atmospheric pressure Pn.

Next, in step 106, it is determined whether the processes in steps 102 to 106 have been executed up to 100 cycles. If not, the processes are repeated up to 100 cycles.

When it is determined that the processes in steps 102 to 106 have been executed up to 100 cycles, then, in step 107, an average ΔA/F_{AV} of the differences ΔA/Fₙ calculated so far is calculated by, for example, dividing the integral value of the differences ΔA/Fₙ by the sample number N and the engine operation cycle number M as described above. Next, in step S108, an average C_{AV} of the correction coefficients Cn calculated so far is calculated by dividing the integral value of the correction coefficients Cn by the sample number N and the engine operation cycle number M.

Subsequently, it is determined in step S109 whether the absolute value of the product of the average ΔA/F_{AV} of the differences A/Fₙ and the average C_{AV} of the correction coefficients Cn is larger than a predetermined abnormality threshold α. If the absolute value of the product is equal to or smaller than the abnormality threshold α, the control proceeds to step S111 where it is determined that any abnormal imbalance is not occurring (“NORMAL”), after which the present cycle of the routine is finished.

Conversely, if it is determined in step S109 that the absolute value of the product is larger than the abnormality threshold a, the control then proceeds to step 110 where it is determined that an abnormal imbalance is occurring (“ABNORMAL”), after which the present cycle of the routine is finished. Meanwhile, when an abnormal imbalance is detected, or when an abnormal imbalance(s) has been detected in two consecutive trips (“trip” represents a period from engine start to engine stop), preferably, an alert device (e.g., an alert lamp) is turned on to inform the user of the abnormality occurrence, and information regarding the detected abnormality is stored in a given diagnosis memory in a form allowing mechanics to read it out as needed.

While an example embodiment of the invention has been described in detail above, the invention may be embodied with various other structures and arrangements. For example, while deviations to the rich side are detected using only the air-fuel ratio sensor outputs obtained when the air-fuel ratio is decreasing (i.e., changing to the rich side) in the foregoing example embodiment, such rich-side deviation detection may alternatively be implemented using only the air-fuel ratio sensor outputs obtained when the air-fuel ratio is increasing (i.e., changing to the lean side), or using both the air-fuel ratio sensor outputs obtained when the air-fuel ratio is decreasing and those obtained when the air-fuel ratio is increasing. Further, deviations to the lean side may be detected, as well as those to the rich side. Further, the air-fuel ratio imbalance detection may be implemented over a wide range, regardless of to which side (rich or lean side) the detected air-fuel ratio deviates.

Further, while the average of the differences ΔA/Fₙ between the detected air-fuel ratios is corrected using the average C_{AV} of the correction coefficients Cn in the foregoing example embodiment, the abnormality threshold α may alternatively be corrected based on the atmospheric pressure. In this case, preferably, a correction coefficient that becomes larger the higher the atmospheric pressure is set using a map or a function, and the values of the correction coefficient are integrated into the abnormality threshold α. In other words, a correction coefficient that becomes smaller the lower the atmospheric value may be set, and the values of the same correction coefficient may be integrated into the abnormality threshold α. Further, the average of the detected air-fuel ratio differences and the abnormality threshold α may both be corrected.

The invention has been described with reference to the example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

What is claimed is:

1. An abnormal inter-cylinder air-fuel ratio imbalance detection apparatus for a multi-cylinder internal combustion engine, comprising:
an air-fuel ratio sensor provided at an exhaust passage of the multi-cylinder internal combustion engine;
an abnormal imbalance detection portion that detects an abnormal imbalance between air-fuel ratios corresponding to respective cylinders of the multi-cylinder internal combustion engine through a comparison between a value of a parameter correlative to a variation of an output of the air-fuel ratio sensor and a predetermined abnormality threshold; and
a correction portion that corrects at least one of the value of the parameter and the abnormality threshold based on an atmospheric pressure.

2. The abnormal inter-cylinder air-fuel ratio imbalance detection apparatus according to claim 1, wherein the correction portion corrects the value of the parameter such that the lower the atmospheric pressure, the larger an absolute value of the variation.

3. The abnormal inter-cylinder air-fuel ratio imbalance detection apparatus according to claim 1, wherein the correction portion corrects the abnormality threshold such that the lower the atmospheric pressure, the smaller an absolute value of the abnormality threshold.

4. The abnormal inter-cylinder air-fuel ratio imbalance detection apparatus according to claim 1, wherein the multi-cylinder internal combustion engine is provided with an exhaust gas recirculation passage interconnecting the exhaust passage and an intake passage.

5. An abnormal inter-cylinder air-fuel ratio imbalance detection method for a multi-cylinder internal combustion engine, comprising:
detecting an air-fuel ratio in an exhaust passage of the multi-cylinder internal combustion engine;
detecting an abnormal imbalance between air-fuel ratios corresponding to respective cylinders of the multi-cylinder internal combustion engine through a comparison between a value of a parameter correlative to a variation of the detected air-fuel ratio and a predetermined abnormality threshold; and
correcting at least one of the value of the parameter and the abnormality threshold based on an atmospheric pressure.

6. The abnormal inter-cylinder air-fuel ratio imbalance detection method according to claim 5, wherein the value of the parameter is corrected such that that the lower the atmospheric pressure, the larger an absolute value of the variation.

7. The abnormal inter-cylinder air-fuel ratio imbalance detection method according to claim 5, wherein the abnormality threshold is corrected such that the lower the atmospheric pressure, the smaller an absolute value of the abnormality threshold.
